(19) United States
(12) Patent Application Publication
(10) Pub. No.: US 2025/0218339 A1
(43) Pub. Date: Jul. 3, 2025

(54) Method of controlling display panel and related display driver circuit and host processor

(71) Applicant: NOVATECK Microelectronics Corp., Hsin-chu (TW)

(72) Inventor: Huan-Teng Cheng, Hsinchu City (TW)

(73) Assignee: NOVATECK Microelectronics Corp., Hsin-chu (TW)

(21) Appl. No.: 18/928,202

(22) Filed: Oct. 28, 2024

Related U.S. Application Data
(60) Provisional application No. 63/614,917, filed on Dec. 27, 2023.

(51) Int. Cl. G09G 3/20

(52) U.S. Cl. CPC G09G 3/2096; G09G 2310/027; G09G 2310/08; G09G 2330/021; G09G 2340/0435; G09G 2360/18

(57) ABSTRACT

A method of controlling a display panel for a display driver circuit includes steps of: starting counting time in a time period for receiving a first frame of display data, to generate a timing result; determining whether a timeout occurs according to the timing result; and outputting a control signal to instruct a host processor to transmit a second frame of display data at a time when the timeout occurs.

### CROSS REFERENCE TO RELATED APPLICATIONS

This application claims the benefit of U.S. Provisional Application No. 63/614, 917, filed on Dec. 27, 2023. The content of the application is incorporated herein by reference.

### BACKGROUND OF THE INVENTION

### 1. Field Of The Invention

The present invention relates to a method of controlling a display panel, and more particularly, to a method of using multi-frequency display (MFD) with adaptive refresh panel (ARP) timing to control a display panel.

### 2. Description Of The Prior Art

In a display system, the application processor (AP) transmits display data to the display driver circuit through a mobile industry processor interface (MIPI). There are two commonly used transmission modes on the MIPI: the command mode and the video mode. Currently available specifications of multi-frequency display (MFD) are mostly developed in the command mode, in which the display driver circuit is equipped with a frame buffer for storing display data received from the AP. However, the prior art has no plans for the application of MED in the RAM-less video mode.

### SUMMARY OF THE INVENTION

It is therefore an objective of the present invention to provide a method of controlling a display panel with the multi-frequency display (MFD) for the video mode, where an adaptive refresh panel (ARP) timing scheme is also applied to achieve power saving.

An embodiment of the present invention discloses a method of controlling a display panel for a display driver circuit. The method comprises steps of: starting counting time in a time period for receiving a first frame of display data, to generate a timing result; determining whether a timeout occurs according to the timing result; and outputting a control signal to instruct a host processor to transmit a second frame of display data at a time when the timeout occurs.

Another embodiment of the present invention discloses a display driver circuit for controlling a display panel. The display driver circuit starts counting time in a time period for receiving a first frame of display data, to generate a timing result; determines whether a timeout occurs according to the timing result; and outputs a control signal to instruct a host processor to transmit a second frame of display data at a time when the timeout occurs.

Another embodiment of the present invention discloses a method of controlling a display panel for a host processor. The method comprises steps of: transmitting a first frame of display data to a display driver circuit for driving the display panel; receiving a control signal from the display driver circuit after transmitting the first frame of display data; and transmitting a second frame of display data in response to the control signal.

Another embodiment of the present invention discloses a host processor for controlling a display panel. The host processor transmits a first frame of display data to a display driver circuit for driving the display panel; receives a control signal from the display driver circuit after transmitting the first frame of display data; and transmits a second frame of display data in response to the control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the refresh operations in 4 consecutive image frames to realize different frame rates in different areas.

FIG. 2 is a schematic diagram of a display system performing the MED operations in the command mode.

FIG. 3 is a schematic diagram of another display system performing the MFD operations in the video mode.

FIG. 4 illustrates the basic timing of MFD applied in the video mode.

FIG. 5 illustrates the timing of MFD with a variable frame rate.

FIG. 6 is a waveform diagram of a display control timing according to an embodiment of the present invention.

FIG. 7 illustrates the timing details of the DDIC switched from the MFD mode to the ARP mode.

FIG. 8 is a waveform diagram of another display control timing according to an embodiment of the present invention.

FIG. 9 illustrates another implementation of switching from the MED mode to the ARP mode.

FIG. 10 illustrates another implementation of switching from the ARP mode to the MED mode.

FIG. 11 illustrates that the DDIC forcibly performs full refresh with a high frequency in multiple frames after entering the MED mode.

FIG. 12 illustrates that the DDIC uses the sequential frequency down-conversion mechanism to control the refresh frequency in partial areas in the MFD mode.

FIG. 13 illustrates a timing diagram where the AP transmits partial display data to the DDIC in the video mode.

FIG. 14 illustrates another alternative embodiment where the AP stops sending the horizontal synchronization signal.

FIG. 15 illustrates the multi-frame rate control with the combination of the vertical direction and the horizontal direction.

FIG. 16 illustrates that the MFD operation is integrated with the ARP mode.

FIG. 17 is a flowchart of a control process according to an embodiment of the present invention.

FIG. 18 is a flowchart of another control process according to an embodiment of the present invention.

### DETAILED DESCRIPTION

According to the present invention, multi-frequency display (MFD) with partial refresh may be implemented in the video mode of the mobile industry processor interface (MIPI). In order to reduce power consumption and be closer to the application of the command mode, when the host processor does not update the image, the image sending frequency through the MIPI may be reduced to achieve a power saving mode in which the frequency of full screen display is reduced to an extremely low frame rate (e.g., 1 Hz). The present invention may incorporate the adaptive refresh panel (ARP) mode of video transmission to realize an automatic switching behavior and complete the timing control of MIPI power saving.

In various embodiments of the present invention, the automatic switching of MED and ARP timing does not require the host processor to send a command. As long as the frequency of the host processor sending images decreases to a certain level, a timeout would be triggered. Based on the timeout determination, the display driver circuit may output a control signal to the host processor, to enter the ARP mode and start the operation of a full-screen frequency down-conversion. When the host processor needs to update images, it may automatically and immediately apply the MFD operation to perform full refresh or partial refresh display, achieving the advanced power saving application function of the RAM-less display driver circuit along with the MFD control.

A brief explanation of MFD will be given as follows. The conventional variable frame rate mechanism is full-screen frame rate adjustment; that is, all pixels on the display panel must be refreshed or not simultaneously during a frame period allocated to display a frame of images. However, in order to meet the applications where dynamic images and still images coexist on the screen, the display panel is allowed to refresh only a part of pixels during a frame period. This is the basic mechanism of MFD.

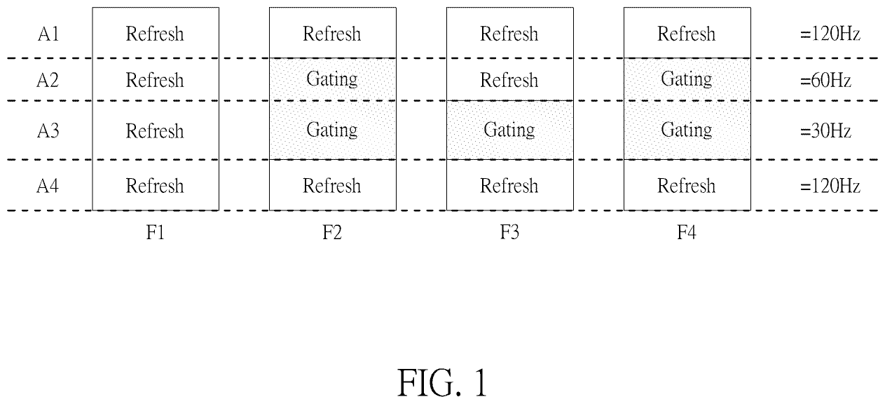

FIG. 1 illustrates the refresh operations in 4 consecutive image frames F1-F4 to realize different frame rates in different areas A1-A4. In the display panel, the image frame F1 is fully refreshed and the image frames F2-F4 are partially refreshed based on the frame rate allocation. More specifically, in the image frames F2 and F4, the areas A2 and A3 are allocated as still image areas, where the scan signals are gated and thus the corresponding pixels are not refreshed, while the panel refresh is performed in the areas Al and A4 which are allocated as dynamic image areas. In the image frame F3, the area A3 is allocated as a still image area, where the scan signals are gated and thus the corresponding pixels are not refreshed, while the panel refresh is performed in the areas A1, A2 and A4 which are allocated as dynamic image areas. Supposing that the basic frame rate of the panel is 120 Hz, the refreshing operations may be repeatedly performed in a series of consecutive image frames as the arrangements shown in FIG. 1, to achieve lower frame rates such as 60 Hz and 30 Hz.

As shown in FIG. 1, the display panel is partitioned into 4 areas A1-A4 having respective frame rates. In fact, the display panel may be partitioned in any appropriate manner based on the image content. In those areas of several image frames where the refresh is not needed, the corresponding gate lines may be gated at a level that turns off the pixels, so that the display data cannot be input to refresh the pixels; while other areas may be refreshed normally. As a result, the dynamic image area may be displayed with a higher frame rate (e.g., 120 Hz) to maintain good image quality, while the still image area may be refreshed with a lower frame rate (e.g., 60 Hz, 30 Hz or even 1 Hz, etc.), in order to achieve the purpose of power saving.

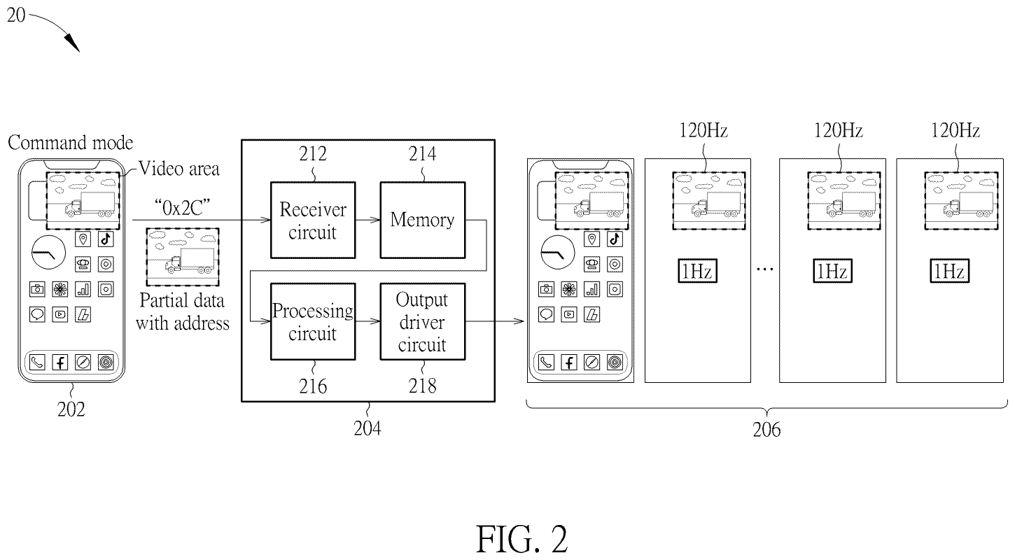

As mentioned above, common MFD specifications are developed in the command mode and applied to a display driver circuit equipped with a frame buffer. FIG. 2 is a schematic diagram of a display system 20 performing the MFD operations in the command mode. The display system 20 includes a host processor 202, a display driver circuit 204 and a display panel 206. The host processor 202, which may be a core processor of the display system 20, may serve as a video source or video provider for providing display data to be displayed by the display panel 206. In an embodiment, the host processor 202 may be an application processor (AP) of a mobile phone or a central processing unit (CPU) of a computer. In the following descriptions, the host processor might be abbreviated as AP, but those skilled in the art would know that the AP described hereinafter may represent any type of processor or processing device capable of controlling the display operations and implemented in any manner.

The display driver circuit 204 may process the display data and convert the display data into data voltages to be output to the pixels on the display panel 206. In an embodiment, the display driver circuit 204 may be implemented in an integrated circuit (IC) to realize a display driver IC (DDIC). In the following descriptions, the display driver circuit will be abbreviated as DDIC, and those skilled in the art would know that the DDIC described hereinafter may represent a display driver circuit capable of driving a display panel and implemented in any manner.

As shown in FIG. 2, the DDIC 204 includes a receiver circuit 212, a memory 214, a processing circuit 216 and an output driver circuit 218. The receiver circuit 212 may receive display data from the AP 202 through the MIPI, and also receive a command (e.g., a “0×2C” command) for writing data into a frame buffer from the AP 202, where the “0×2C” command could be a command for data writing into the frame buffer defined by the MIPI specification. The frame buffer may be implemented in the memory 214. Examples of the memory 214 may include a random access memory (RAM), but not limited thereto. The processing circuit 216 may process and adjust the display data for satisfying various purposes such as improving the visual effects and/or enhancing the image quality. The output driver circuit 218 may output display data voltages to the display panel 206, and also output the corresponding gate/emission control signals to turn on the corresponding pixels to receive the display data voltages.

The display panel 206 may be any type of display device, which may be, but not limited to, an organic light emitting diode (OLED) panel, liquid crystal display (LCD) panel, or any other panel performing display by receiving scan control.

When the AP 202 transmits display data to the DDIC 204, the display data could be written into the frame buffer implemented in the memory 214. Based on the display data stored in the frame buffer, the DDIC 204 may use an internal clock to control the panel refresh timing by itself, to perform full-screen frame rate conversion or MFD timing control. Through the panel refresh timing of the DDIC 204, the output driver circuit 218 may output the display data voltages to the display panel 206 at predetermined time points, and the gate control signals may be output to a gate on array (GOA) circuit of the display panel 206 correspondingly. In the example shown in FIG. 2, the dynamic video area near the top may be displayed with a high frame rate of 120 Hz, and other areas may display still images with a frequency down to 1 Hz to save power, i.e., one refresh in every 120 frames.

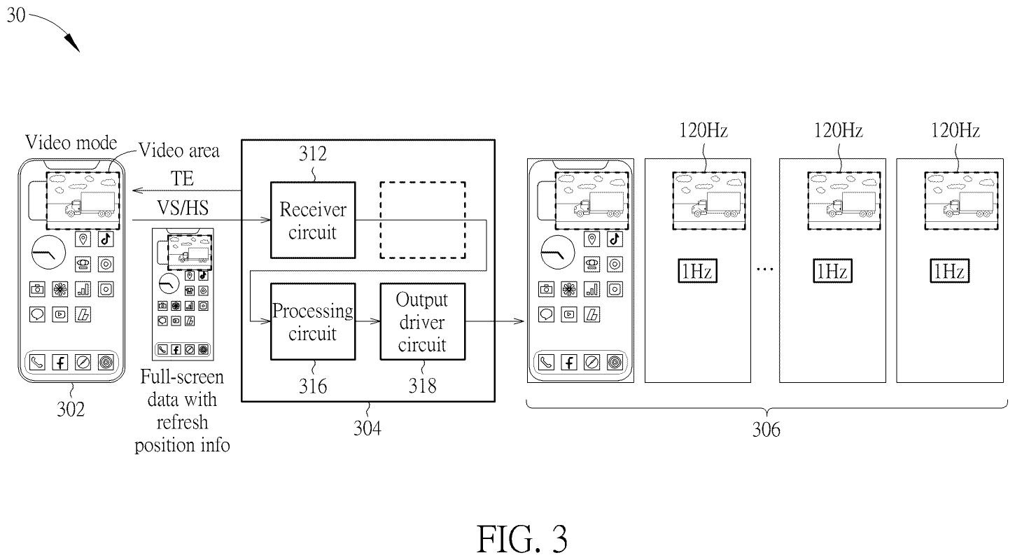

However, in order to reduce circuit costs, the display system might change to use a RAM-less DDIC with the MIPI video mode to send images. For example, FIG. 3 is a schematic diagram of another display system 30 performing the MFD operations in the video mode. The display system 30 includes an AP 302 (or any type of host processor), a DDIC 304 (or any type of display driver circuit) and a display panel 306. The DDIC 304 may further include a receiver circuit 312, a processing circuit 316 and an output driver circuit 318. The operations of the AP 302, the DDIC 304 and the display panel 306 are similar to those of the AP 202, the DDIC 204 and the display panel 206, respectively, except that the DDIC 304 includes no memory for implementing the frame buffer.

In the video mode, there is no frame buffer in the DDIC 304; therefore, when the AP 302 transmits display data to the DDIC 304, the DDIC 304 may directly forward the display data to the display panel 306 to perform refresh. The DDIC 304 may receive a vertical synchronization signal VS and a horizontal synchronization signal HS from the AP 302 to perform frame rate conversion. More specifically, the DDIC 304 may start the next frame period only when receiving a packet of the vertical synchronization signal VS. The main difference in the timing between the video mode and the command mode is that, the DDIC 304 in the video mode, which is mainly controlled by an external clock, performs panel refresh control through the timing control signals sent from the AP 302, and these timing control signals may include the vertical synchronization signal VS and the horizontal synchronization signal HS. In contrast, the panel refresh operation in the command mode reads out the display data from the frame buffer of the DDIC 304 itself, and its display timing is completely controlled by the DDIC 304 itself.

Therefore, under the transmission architecture of the video mode, the implementation of MED is slightly different from that under the command mode. In the command mode (as shown in FIG. 2), the display data transmitted to the DDIC 204 is along with a write command (e.g., “0×2C”) to be stored into the frame buffer. When the AP 202 outputs the display data, it would additionally send address information to indicate which address of the frame buffer or the memory 214 the display data should be written into. At this time, the AP 202 may only output partial display data that need to be updated to the DDIC 204. In contrast, in the video mode (as shown in FIG. 3), the display data are not written into the frame buffer but directly sent to the display panel 306 for refresh; hence, the AP 302 may send the synchronization signals VS and HS for timing control instead of the write command, so that the DDIC 304 may perform panel refresh by using the synchronization signals VS and HS from the AP 302.

In addition, the address information sent with the display data in the command mode should be replaced with the position information of the display lines or pixels to be refreshed in the video mode. According to the current MIPI specification, the AP should transmit full-screen display data to the DDIC in the video mode, and the DDIC may refresh partial pixels based on the position information provided by the AP, so as to realize the MFD control in the video mode.

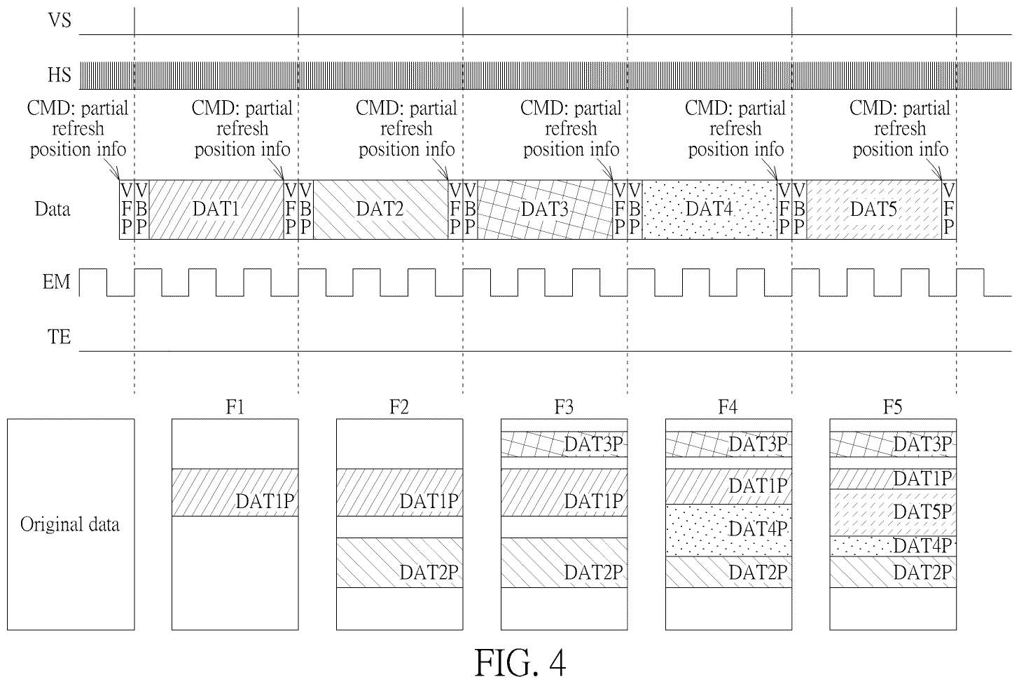

FIG. 4 illustrates the basic timing of MFD applied in the video mode, where a vertical synchronization signal VS, a horizontal synchronization signal HS, display data, an emission control signal EM, and a control signal TE are shown. The AP may send the synchronization signals VS and HS to control the timing of the DDIC performing panel refresh, where the vertical synchronization signal VS may be sent through the MIPI, and the horizontal synchronization signal HS may be sent through the MIPI or another general purpose output (GPO) interface.

As mentioned above, since the current MIPI specification instructs the AP to transmit full-screen display data to the DDIC in the video mode, those sent through the MIPI include the full-screen display data, vertical back porch (VBP) and vertical front porch (VFP). A command CMD carrying the position information of the partial display lines that need to be refreshed may also be sent. Therefore, based on the position information of the display lines to be refreshed, the DDIC may extract the corresponding display data to refresh the corresponding pixels on the display panel, and ignore other unused display data. In this embodiment, the command CMD carrying the position information of the display lines to be refreshed is sent in the VFP of the previous frame, but those skilled in the art should know that the AP may provide the command to the DDIC in any manner (such as in other positions of MIPI channels or through other transmission interfaces), which is not limited herein.

As shown in FIG. 4, the AP may transmit the full-screen display data DAT1-DAT5 for image frames F1-F5, respectively, and also send commands CMD carrying the position information of the display lines to be refreshed. Therefore, the DDIC may refresh the pixels in the display lines that need to be refreshed in the image frames F1-F5 with partial display data DAT1P-DAT5P, so as to realize the MED operation. The partial display data DAT1P-DAT5P are parts of the full-screen display data DAT1-DAT5, respectively, as indicated by the corresponding commands CMD for partial refresh. For example, the partial display data DATIP is a part of the display data DAT1 in the refresh area of the image frame F1, the partial display data DAT2P is a part of the display data DAT2 in the refresh area of the image frame F2, and so on.

In addition, if the DDIC is configured to drive an LED panel or OLED panel, the DDIC is requested to output the emission control signal EM to control the timing of light emission. As shown in FIG. 4, the pulses of the emission control signal EM are preferably synchronized with the vertical synchronization signal VS to avoid display brightness errors between image frames. The control signal TE is a signal that the DDIC uses to instruct the AP to output display data, and may be sent through another GPO interface. For example, as shown in FIG. 3, the DDIC 304 may send the control signal TE to the AP 302. In FIG. 4, since the AP actively updates partial images in the image frames F1-F5, the DDIC may not need to output any pulse of the control signal TE.

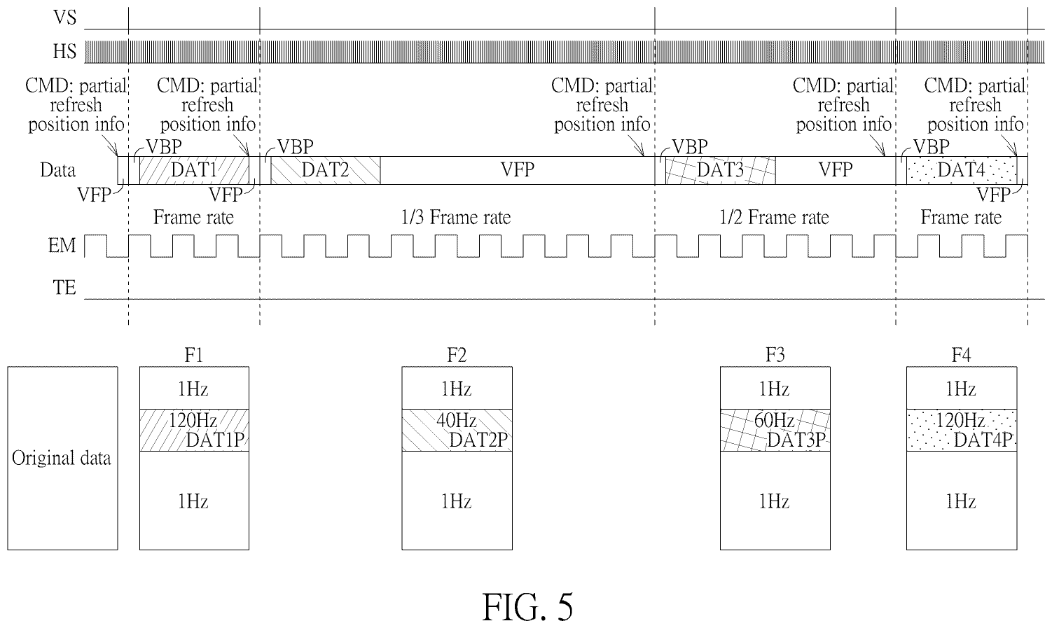

In the video mode, since the DDIC performs panel refresh control entirely based on the external synchronization signal received from the AP, when the frequency of the external synchronization signal changes, the panel refresh timing of the DDIC may also be adjusted accordingly. For example, under a variable refresh rate, the transmission timing of the vertical synchronization signal VS may be variable, and the AP may change the frequency by extending the VFP. As shown in FIG. 5, the AP may control the frame rate to dynamically fall to ½ or ⅓ of its initial value, and the time from the display data (e.g., DAT2 and DAT3) completely transmitted to the next vertical synchronization signal VS is set as an extended VFP interval. In this embodiment, assuming that the original frame rate equals 120 Hz, the frame rates of the image frames F2 and F3 are decreased to 40 Hz and 60 Hz, respectively, with the extended VFP interval.

Similarly, under the display architecture of a variable frequency or variable frame rate, the DDIC may also perform partial refresh in the same manner; that is, determine the position of the display pixels that need to be refreshed according to the position information received from the AP and refresh the designated areas with the partial display data (e.g., DAT1P-DAT4P) with the predetermined frequencies, thereby achieving different refresh rates in different areas on the display panel.

The MIPI Association has proposed an ARP mechanism that could perform sequential frequency down-conversion in the video mode. The low temperature polycrystalline oxide (LTPO) panel supports an extremely low frame rate such as 1 Hz. If the display panel is directly switched to the extremely low frame rate of 1 Hz from the display of a high frame rate of 120 Hz, the significant frequency drop would easily cause visual effect problems such as screen flickering. Therefore, a sequential frequency down-conversion mechanism is necessary, such as from 120 Hz, 60 Hz, 30 Hz, and 15 Hz down to 1 Hz sequentially. In the command mode, the display data are stored in the frame buffer of the DDIC, so the DDIC may generate the timing of sequential frequency down-conversion by itself. However, in the video mode, the DDIC is not equipped with a frame buffer but receives the vertical synchronization signal from the AP for timing control, so the ARP mechanism should be used to realize the communications between the DDIC and the AP, to achieve the sequential frequency down-conversion control; that is, the frequency of the vertical synchronization signal and display data output is sequentially reduced until the target frequency (e.g., 1 Hz) is reached.

When the DDIC needs to refresh the panel, it may output a control signal (i.e., the control signal TE shown in FIGS. 3-5) to the AP, to instruct the AP to transmit a frame of display data. According to the ARP, the DDIC may gradually reduce the frequency of outputting the control signals TE (i.e., gradually extend the interval of sending the control signals TE), so that the timing of the AP outputting display data meets the requirements of sequential frequency down-conversion refresh. As mentioned above, the control signal TE may be sent through a GPO interface connected between the AP and the DDIC. In various embodiments of the present invention, the control signal TE may refer to a pulse generated on a control pin such as a GPO pin, and the interval between the control signals TE may refer to the interval between two pulses on the control pin used to forward the control signal TE.

Sometimes the AP may need to actively update the image content. At this time, the AP would send updated display data to the DDIC regardless of whether it receives the control signal TE. For example, the user of the mobile phone may send a touch command to trigger an application and enter a new image. At this time, the AP needs to actively send new display data to the DDIC. When the AP actively sends the display data, the display panel may return to the high frequency display of 120 Hz, until the images are no longer updated. When the AP does not actively update the image content, it needs to be triggered by the control signal TE to send images. At this time, the DDIC may output the control signal TE to the AP at suitable time points to control the AP to gradually reduce the image sending frequency to an extremely low frequency (e.g., 1 Hz) using the sequential frequency down-conversion mechanism.

In the present invention, the applications of ARP timing and MED timing may be combined under the display architecture of the video mode, to enhance the power saving effect of the display system. The ARP mode is an operation of the MIPI forwarding images with sequentially down-converted frequencies to enter a low-frequency power saving mode under a still image, and the MED is a mechanism that the dynamic image areas on the display panel perform high-speed refresh while other areas apply a lower refresh rate. In the embodiments of the present invention, the AP does not need to send any command for mode switching to the DDIC, and the DDIC may be switched between the ARP mode and the MED mode. In other words, the DDIC may switch the operation mode without being instructed by a command received from the AP.

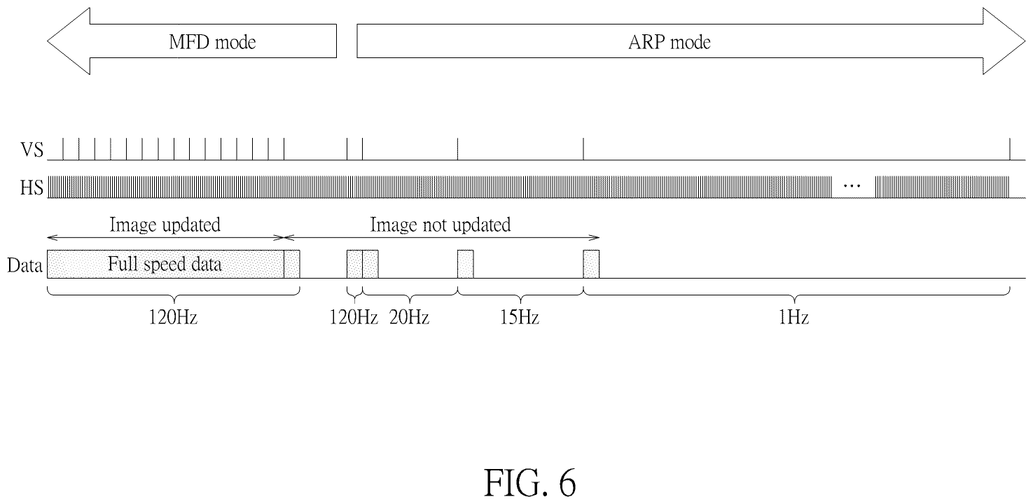

FIG. 6 is a waveform diagram of a display control timing according to an embodiment of the present invention, where the display architecture of the video mode is applied and the DDIC may not have a frame buffer. FIG. 6 illustrates the waveforms of various signals sent through the MIPI connected between the AP and the DDIC, which may include a vertical synchronization signal VS, a horizontal synchronization signal HS, and display data. In this embodiment, the AP may apply the ARP operation to send images with sequentially down-converted frequencies. While outputting each frame of display data, the AP may also send the position information of the display lines to be updated, allowing the DDIC to select several pixels on the display panel to perform partial refresh. During the ARP operation, the AP may actively transmit display data to the DDIC when it needs to update images, and may also transmit display data to the DDIC due to the instruction of the control signal TE received from the DDIC.

FIG. 6 illustrates the timing switched from the MFD mode to the ARP mode. First, the display images are mainly dynamic images, so the AP continuously updates images and transmits a series of frames of display data to the DDIC through the MIPI at a full speed. The DDIC may be in the MFD mode, where the DDIC performs partial refresh (i.e., refresh partial pixels on the display panel) with the received display data. At this time, the power consumption required by the system is relatively larger, but a certain degree of power saving could still be achieved with the partial refresh operation.

Subsequently, when the display images stop changing (i.e., converted into a full-screen still image), the AP stops updating images and starts to reduce the frequency of outputting display data. At this time, the frequency of display data sent through the MIPI decreases, and the interval between adjacent vertical synchronization signals VS also becomes longer. In such a situation, the DDIC leaves the MED mode and enters the ARP mode. In order to avoid the visual effect problems caused by a sudden drop of the display frequency, the DDIC may output the control signals TE (not illustrated) at specific time points to instruct the AP to transmit display data, thereby controlling the AP to output display data to the DDIC with sequentially down-converted frequencies. The detailed settings of the sequential frequency down-conversion may be arranged arbitrarily according to system requirements. In this embodiment, the image sending frequency of the AP could be decreased sequentially from 120 Hz, 20 Hz, 15 Hz, to 1 Hz.

In other words, in the ARP mode, the DDIC actively outputs the control signals TE to control the AP to send images with sequentially down-converted frequencies based on the predetermined timing sequence, and the AP sends images according to the instruction of the control signals TE. In such a situation, the refresh rate in the ARP mode is mainly controlled by the DDIC.

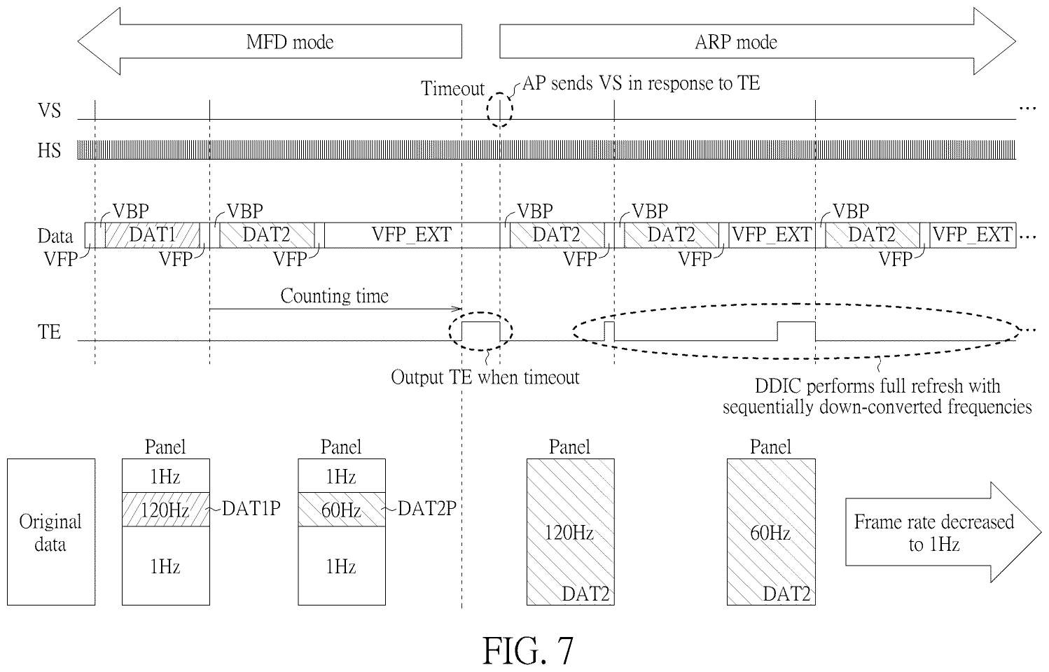

In an embodiment, the DDIC may determine whether to enter the ARP mode through time counting. For example, FIG. 7 further illustrates the timing details of the DDIC switched from the MFD mode to the ARP mode. In addition to the vertical synchronization signal VS, the horizontal synchronization signal HS and the display data, FIG. 7 also illustrates the waveform of the control signal TE and the panel refresh behavior under the mode switching operation.

As shown in FIG. 7, the DDIC is first in the MFD mode where the display panel is partially refreshed with partial display data DAT1P and DAT2P in the dynamic image area based on the display data DAT1 and DAT2 received from the AP. Similarly, a command carrying the position information of the partial display lines that need to be refreshed may be sent through the previous VFP or any other time slot, and is omitted in FIG. 7 for brevity. Based on the image content, the AP may send images with a variable frame rate, where a decreased frame rate may be realized by incorporating an extended VFP interval VFP EXT.

The DDIC may start counting time in each time period for receiving a frame of display data. More specifically, the DDIC may start counting time every time it receives a vertical synchronization signal VS from the AP, where the vertical synchronization signal VS indicates the start of a time period for transmitting a frame of display data. The DDIC may also set a timeout length, so as to determine whether a timeout occurs according to the timing result. The DDIC may determine that the timeout occurs and enter the ARP mode when the timing result indicates that no vertical synchronization signal VS is received for a predetermined period of time exceeding the timeout length. The timeout means that the AP does not actively update images for more than a period of time, which means that the frequency of the vertical synchronization signal VS output by the AP falls below a certain level. For example, the DDIC may set the timeout length to an appropriate value so that it is expected to enter the ARP mode when the frequency of the output vertical synchronization signal VS falls below 20 Hz, which means that the image sending frequency of the AP falls below 20 Hz.

At the time of expiring/timeout, the DDIC may leave the MED mode to enter the ARP mode. The DDIC may also output a control signal TE to the AP to indicate that the operation mode is switched to the ARP mode. In response to the control signal TE, the AP would transmit a frame of display data and send a vertical synchronization signal VS indicating the corresponding frame period. In an embodiment, the DDIC may pull high the level of a corresponding GPO pin to deliver the control signal TE through the GPO interface. Since the AP does not actively send images due to image changing, the output display data may be the same as the previous frame of display data (i.e., DAT2). Subsequently, in the ARP mode, the DDIC may output control signals TE at several specific time points according to the ARP specification of MIPI. The AP, which is triggered by the received control signals TE, may transmit a series of frames of display data based on the timing of sequentially down-converted frequencies, making the frame rate gradually decrease to 1 Hz.

The above time counting scheme used for determining the occurrence of timeout may be implemented in any manner. In an embodiment, a timeout counter may be applied to calculate the number of horizontal synchronization signals HS continuously received after the DDIC receives the vertical synchronization signal VS, so as to determine whether the timeout occurs. Therefore, when the number of accumulated horizontal synchronization signals HS exceeds a specific value, the DDIC determines that a timeout occurs and thereby enters the ARP mode.

In such a situation, when the AP stops updating display data and enters a low-frequency display period, there is no need to send additional commands or notifications to the DDIC. The DDIC may use a timeout counter or timer to determine the timeout and decide whether to enter the ARP mode based on the occurrence of timeout, so as to realize the full-screen frequency down-conversion mechanism. In contrast, in the conventional ARP mode, the AP is requested to send a command to the DDIC to notify the DDIC to enter the ARP mode. In the conventional method, it is difficult for the AP to efficiently determine that the MFD mode of high-frequency image sending or the ARP mode of low-frequency image sending is suitable under various usage scenarios, and thus the power saving effect is quite limited.

In an embodiment of the present invention, in order to avoid the visual effect problems, the DDIC may forcibly perform full refresh with a frame of display data after entering the ARP mode, i.e., suspend the partial refresh operation of MFD. In the full refresh operation, the DDIC may refresh all pixels on the display panel by using the entire frame of display data (e.g., DAT2). This is because when the display panel is refreshed with an extremely low refresh rate (e.g., 1 Hz), if the partial refresh mechanism is incorporated, the display frequency in the non-refresh area may drop to less than 1 Hz, or even less than 0.1 Hz. However, the excessively low refresh rate would reduce the smoothness of the images and/or cause other unexpected visual effect problems. Therefore, it is preferable to forcibly perform full refresh in the ARP mode, in order to maintain the display quality.

Therefore, when entering the ARP mode, the DDIC may perform full refresh with the sequentially down-converted frequencies of, for example, 120 Hz, 60 Hz . . . , to the extremely low frame rate of 1 Hz, as shown in FIG. 7. At this time, although the AP may still send the information of the display lines to be refreshed while sending images, the DDIC may ignore this information and forcibly perform full refresh.

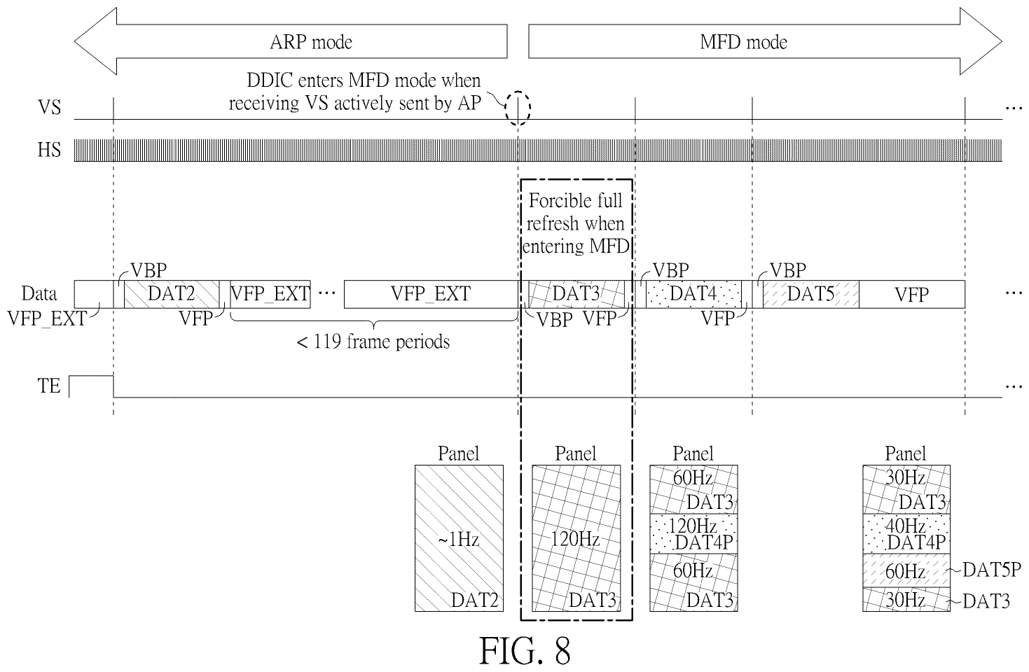

FIG. 8 is a waveform diagram of another display control timing according to an embodiment 41 invention, which illustrates the timing control of the DDIC leaving the ARP mode and entering the MFD mode. Similarly, the vertical synchronization signal VS, horizontal synchronization signal HS, display data and control signal TE delivered between the AP and the DDIC are shown. In this embodiment, the DDIC may be originally in the ARP mode, where the display data (i.e., DAT2) keep unchanged and the AP may transmit the display data with an extremely low frequency such as 1 Hz.

When the AP needs to actively update display images, it would actively send the vertical synchronization signal VS and transmit a new frame of display data to the DDIC. At this time, the DDIC may return to the MED mode. As for the DDIC, it is configured to instruct the AP to send images at specific time points by outputting the control signals TE to realize the extremely low frequency in the ARP mode. However, if the DDIC receives a new frame of display data from the AP but this new frame of display data is not in response to the control signal TE, which means that the display data are not received at the time point indicated by any control signal TE and expected by the DDIC, this new display data may be the images sent by the AP to actively update the image content. In such a situation, the DDIC may determine that the AP starts to update the images, and thereby leave the ARP mode to enter the MED mode.

As mentioned above, the DDIC may send the control signal TE to instruct the AP to send images. In the embodiment as shown in FIG. 8, the control pin of TE may be in the low level in usual. When the DDIC requests the AP to send images, it pulls the control pin to the high level as an output control signal TE and the AP may send the vertical synchronization signal VS with a frame of display data accordingly. However, if the AP outputs the vertical synchronization signal VS while the control pin of TE is still in the low level, the next image sent by the AP would be the actively updated display data, and the DDIC may enter the MFD mode in response to the reception of the display data.

Note that in a preferable embodiment, full refresh should be forcibly performed in the first frame (or the first few frames) when the DDIC just enters the MFD mode. In general, in the ARP mode, the frequency of the AP sending images may decrease to approximately a 1-Hz level. Entering the MFD mode means that the AP actively updates the display data, where the AP may update full images or partial images based on the image content. Therefore, if the low-frequency display is still performed in some still image areas when the DDIC enters the MFD mode, the tearing effect, dropped images, or other unpredictable visual effect problems may occur. In such a situation, the forcible full refresh in one or more frames may be applied to solve the problems. At this time, although the AP may send the information of the display lines to be refreshed while sending images, the DDIC may ignore this information and perform the full refresh.

In the embodiment as shown in FIG. 8, after the DDIC receives the display data DAT2, the timing has not reached the start of the next frame period and the control signal TE of the next frame period is not output. For example, the length of the extended VFP interval VFP EXT has not reached the predetermined length such as 119 blank frame periods (e.g., under a 1-Hz frame rate). At this time, the DDIC receives the vertical synchronization signal VS with the next frame of display data DAT3 from the AP. In such a situation, the DDIC performs full refresh with the display data DAT3 in this image frame, regardless of whether the AP sends the information of partial display lines that need to be refreshed. Subsequently, the DDIC and the AP would be operated in the MED mode normally, where the AP may update display data in the dynamic image areas, and the DDIC receives the display data (e.g., DAT4 and DAT5) and performs partial refresh on the display panel accordingly (e.g., with the partial display data DAT4P and DAT5P), to realize different frame rates in different areas of the MFD operations, thereby achieving the power saving effects of MED.

As can be seen, the present invention aims at providing a timing control mechanism that allows the DDIC to be switched between the MFD mode and the ARP mode in the MIPI video mode. Those skilled in the art may make modifications and alterations accordingly. For example, the timing in FIG. 7 is only one of various implementations of the DDIC switched from the MFD mode to the ARP mode, and the timing in FIG. 8 is only one of various implementations of the DDIC switched from the ARP mode to the MED mode. Under the display architecture of the video mode, the display control timing of the present invention may be adjusted or changed in many different aspects, which should all belong to the scope of the present invention.

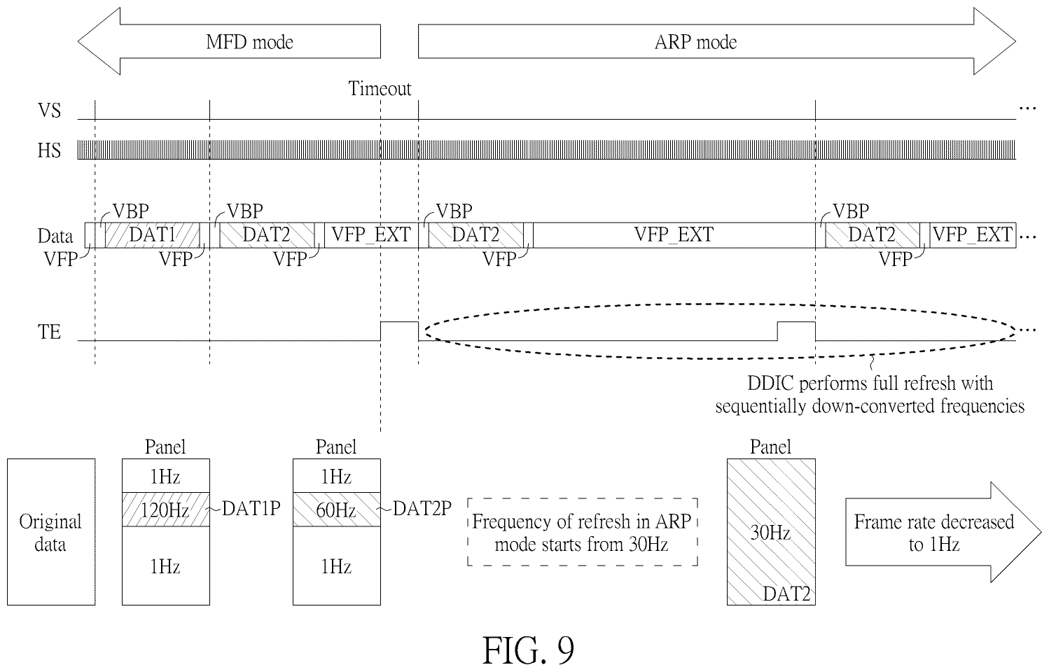

FIG. 9 illustrates another implementation of switching from the MFD mode to the ARP mode. Similarly, the DDIC may send a control signal TE to instruct the AP to send images at the occurrence time point of timeout. However, the timeout length setting and/or the refresh frequency when the DDIC enters the ARP mode may be adjusted to appropriate values according to system requirements. In an exemplary embodiment, when the DDIC enters the ARP mode, the display data from the AP may be transmitted with a start frequency, and the start frequency may be determined according to the timeout length.

Referring back to FIG. 7, the DDIC may leave the MFD mode to enter the ARP mode when the frequency of the AP sending images falls to a lower frequency such as 20 Hz. After entering the ARP mode, the DDIC first refreshes the display panel with a frame rate of 120 Hz, and then the refresh frequency is decreased sequentially. In such a situation, there may be a larger frequency gap between the MED mode and the ARP mode. In order to make the frequency conversion when entering the ARP mode smoother, the DDIC may directly refresh with an appropriate frequency (e.g., 30 Hz) after entering the ARP mode, where the equivalent refresh frequency when the timeout occurs may be equal to 60 Hz. Subsequently, the DDIC may use the sequential frequency down-conversion mechanism of the ARP to gradually reduce the refresh frequency to 1 Hz, thereby achieving a smooth frequency down-conversion, as shown in FIG. 9.

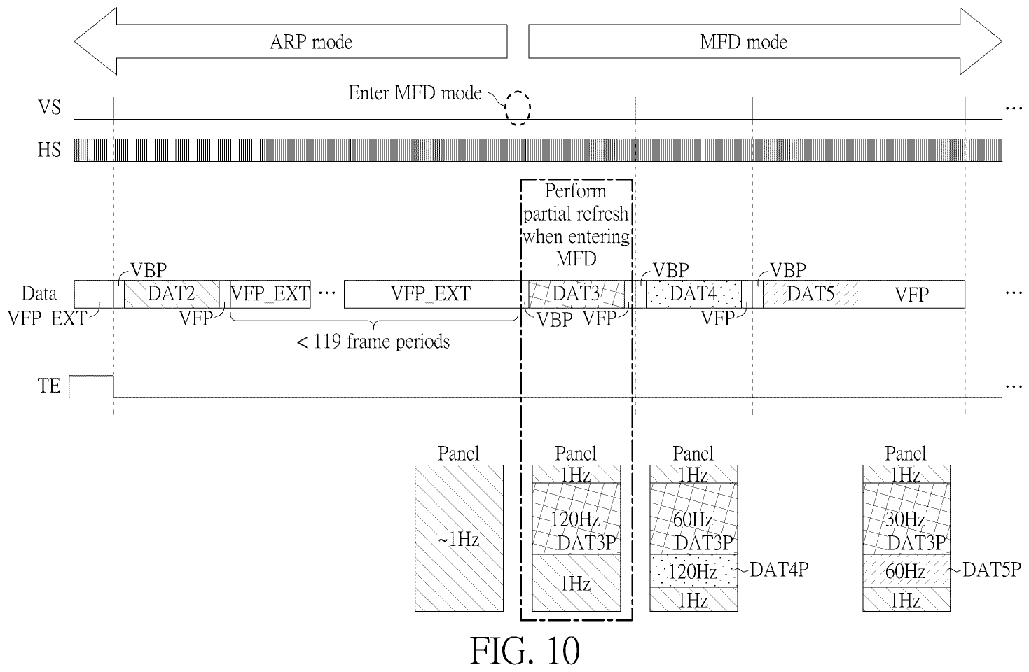

FIG. 10 illustrates another implementation of switching from the ARP mode to the MFD mode. Similarly, when receiving a vertical synchronization signal VS which is not in response to the instruction of a control signal TE, the DDIC may determine that the AP needs to actively send images, and would be switched to the MED mode accordingly. However, the operation of refreshing the display panel after the DDIC enters the MED mode may be adjusted according to system requirements. In an exemplary embodiment, the DDIC may perform partial refresh in the first frame in the MFD mode according to the command which indicates the position or display lines on the display panel that need to be refreshed.

Referring back to FIG. 8, the first frame after the DDIC enters the MFD mode may be forced to be fully refreshed to avoid visual effect problems. In contrast, in the embodiment of FIG. 10, the first frame after the DDIC enters the MFD mode is not forced to be fully refreshed, but performs partial refresh with the partial display data DAT3P based on the information of the display lines to be refreshed provided by the AP. This information may be sent through any interface between the AP and the DDIC, such as the VFP of the MIPI, which is omitted in FIG. 10 for brevity. The DDIC then proceeds with the partial refresh operations by using the partial display data DAT4P and DAT5P extracted from the full-screen display data DAT4 and DAT5.

For example, under a certain application, the display system may have a higher requirement for power saving than image quality. Therefore, multi-frequency refresh with partitioning may be started when the DDIC enters the MFD mode, so that the power saving effect of MED may be optimized.

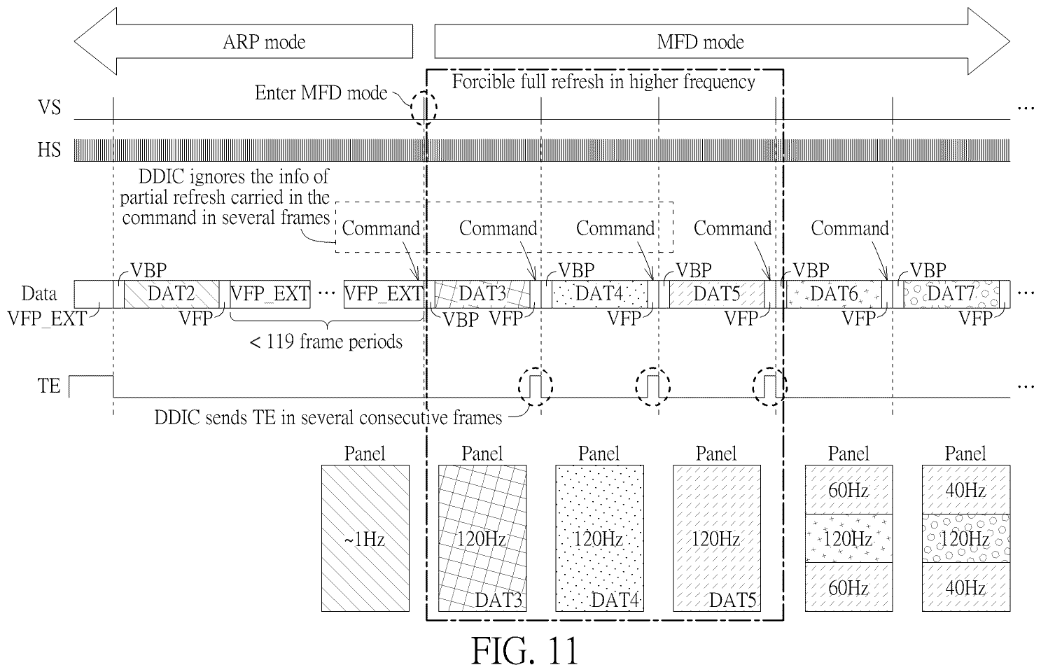

In another embodiment, when entering the MFD mode from the ARP mode, the DDIC may forcibly perform full refresh with a higher frequency several times to ensure good visual effects. In other words, the DDIC may be forced to perform full refresh with the received display data of a predetermined number of frames after entering the MED mode. For example, as shown in FIG. 11, when receiving the vertical synchronization signal VS which is not in response to the control signal TE output by the DDIC, the DDIC enters the MED mode from the ARP mode. At this time, the DDIC may receive updated display data (e.g., DAT3, DAT4 . . . ) along with the information of the positions or display lines of partial refresh from the AP. In the first three frame periods after entering the MFD mode, the DDIC may send control signals TE to instruct the AP to transmit display data DAT3-DAT5 and uses the received display data DAT3-DAT5 to fully refresh the display panel (i.e., ignoring the information of the positions or display lines of partial refresh carried in the command of the AP), thereby ensuring that the display panel is fully refreshed with a basic frequency such as 120 Hz. Partial refresh may start in subsequent image frames.

Under several applications, the display system may be playing a video in a relatively lower frame rate such as 30 Hz, and thus the AP may send images with this lower frame rate. If the display panel is refreshed with a lower frequency when the DDIC enters the MED mode, several visual effect problems such as the screen flickering, image sticking, or tearing effect may occur. In order to solve this problem, the DDIC may forcibly perform full refresh with a higher frequency in several consecutive frames after entering the MFD mode. Therefore, the DDIC should output the control signals TE with a higher frequency in several consecutive frames, to ensure that the AP sends images with a higher frequency, allowing the display panel to perform high-frequency full refresh. As a result, various visual effect problems due to the display panel entering partial refresh of the MFD mode under a lower-frequency display state may be avoided. In the embodiment shown in FIG. 11, the DDIC performs full refresh with a refresh rate of 120 Hz in three consecutive frame periods. In another embodiment, when entering the MED mode, the DDIC may forcibly fully refresh the display panel in N image frames with 120 Hz, 60 Hz or any other suitable frequency, where N may be any positive integer.

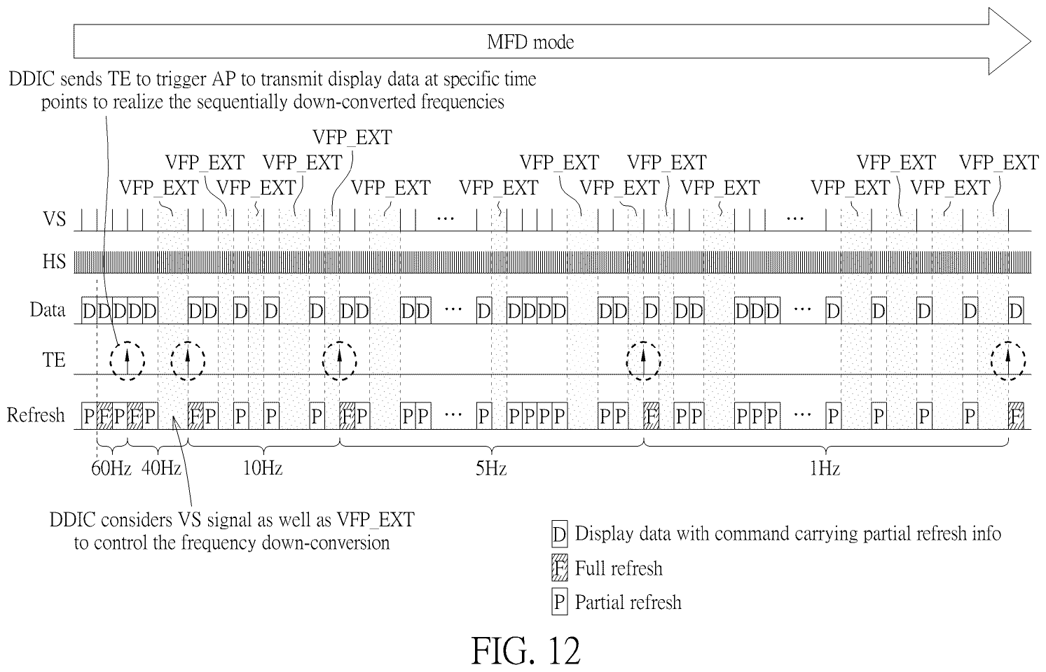

In another embodiment, the DDIC may also use the sequential frequency down-conversion mechanism to control the refresh frequency in partial areas in the MFD mode. For example, as shown in FIG. 12, in the MFD mode, the AP may continuously transmit full-screen display data along with the information of the display lines to be refreshed to the DDIC, and the DDIC performs partial refresh on the panel accordingly. Considering the visual effect problems that may occur if the refresh rate suddenly drops from 120 Hz to 1 Hz in some areas with dynamic images converted into still images, the ARP mechanism may be used to perform sequential frequency down-conversion.

In such a situation, the DDIC may output the control signals TE to instruct the AP to transmit entire frames of display data with sequentially down-converted frequencies, such as from 60 Hz, 40 Hz, 10 Hz, 5 Hz, to 1 Hz in the embodiment shown in FIG. 12. In response, the AP may transmit the entire frames of display data to the DDIC at the specific time points indicated by the control signals TE. Therefore, the DDIC may refresh the display panel with the entire frames of display data in the corresponding frame periods following the sequentially down-converted frequencies, where the information of partial refresh for these image frames may be ignored.

The DDIC may calculate the time points to perform full refresh based on the setting of frequency down-conversion, and send the control signals TE at these time points to instruct the AP to send images. The DDIC may also forcibly perform full refresh in the corresponding frame periods, while other frame periods may be applied with partial refresh in the positions indicated by the command of the AP if any display data are received. More specifically, the full refresh may be performed with the sequentially down-converted frequencies, while the partial refresh (or might be full refresh) may still be performed in other frame periods where the images are partially or fully updated and the corresponding display data are transmitted by the AP.

Note that in the MFD mode, the AP may adjust the image sending frequency by itself based on whether the image content needs to be updated and its updating frequency. For example, the AP may reduce the image sending frequency by extending the VFP (i.e., VFP EXT) to extend the interval between the vertical synchronization signals VS. In such a situation, the time points to perform full refresh (i.e., the time points of sending the control signals TE) calculated by the DDIC should be adapted to the actual timing, and cannot be calculated solely by using the vertical synchronization signals VS. In other words, the DDIC may determine the frequency down-conversion by considering the vertical synchronization signals VS as well as the length of the extended VFP intervals (i.e., VFP EXT), and/or may count the frequencies in consideration of the absolute time containing the data transmission periods and the extended VFP intervals. In an embodiment, the DDIC may use a counter to count the number of horizontal synchronization signals HS, or use a timer to calculate the real time, in order to achieve an effective sequential frequency down-conversion control.

Under the display architecture of the MIPI video mode, the present invention provides the switching control between the MFD mode and the ARP mode for a display system, in order to achieve the purpose of power saving while ensuring the display quality. The above embodiments are only used for illustrating exemplary methods of signal transmission between the AP and the DDIC, but the present invention is not limited thereto. The following embodiments illustrate more feasible variations.

In the above embodiments, according to the MIPI specification, regardless of whether the display panel needs to perform full refresh or partial refresh, the AP should transmit full-screen display data to the DDIC in a predetermined format, and the DDIC selects the areas to be refreshed based on the information of the display lines that need to be refreshed carried in the command sent by the AP. In other embodiments, the AP is allowed to transmit only parts of the display data to be refreshed to the DDIC. In such a situation, if only several areas on the panel need to be refreshed, the AP may only transmit the display data in the corresponding time slots.

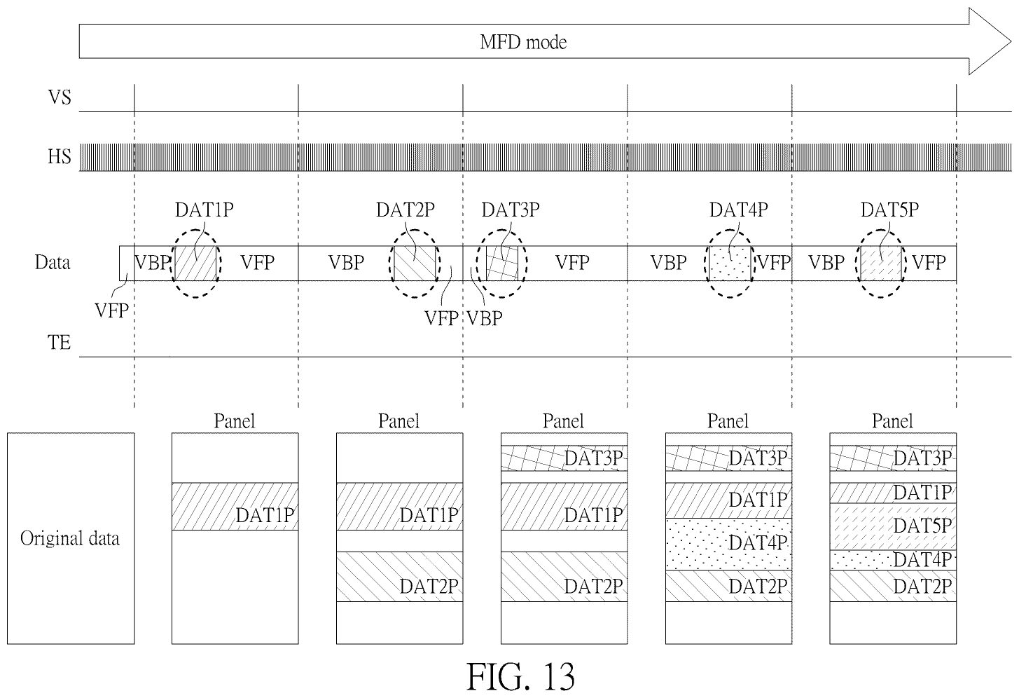

FIG. 13 illustrates a timing diagram where the AP transmits partial display data DAT1P-DAT5P to the DDIC in the video mode. When the MFD operation is applied in the video mode, the DDIC is configured to refresh partial areas on the panel; hence, the AP may only transmit the display data DAT1P-DAT5P at the corresponding pixels that need to be refreshed in the time slots allocated to these display data, while other time slots may be left blank (or used to carry other information). In this embodiment, the AP may still send the commands indicating the positions of partial refresh. Alternatively, the DDIC may perform partial refresh only based on the partial display data DAT1P-DAT5P that received through the MIPI, and thus the related commands may not be necessary.

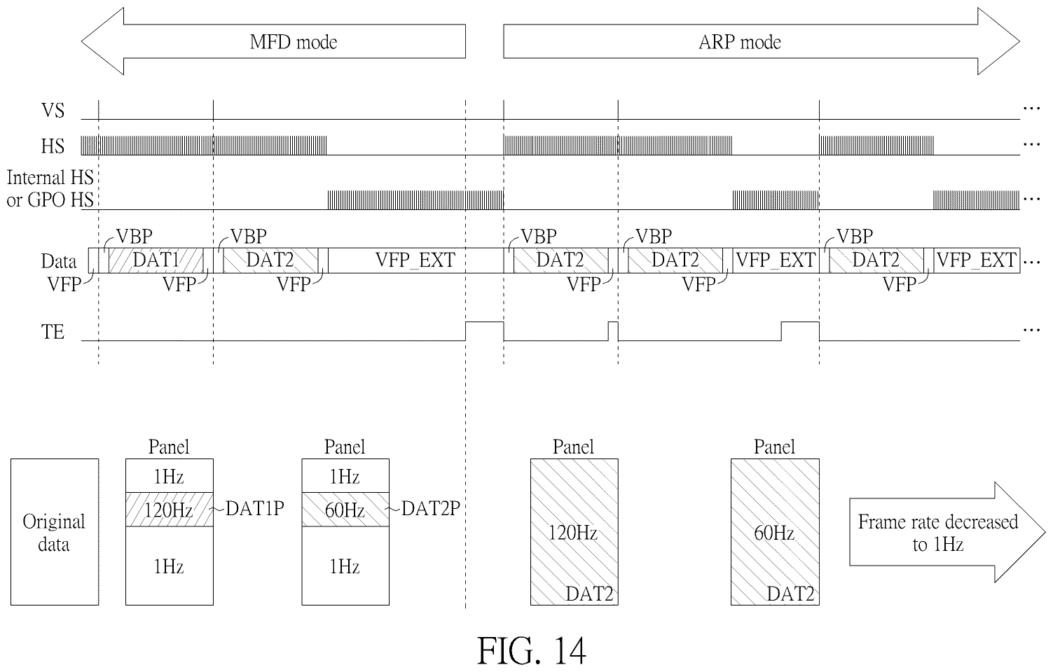

FIG. 14 illustrates another alternative embodiment. As mentioned above, the ARP scheme mainly aims at power saving, where an extremely low frame rate may be achieved through a sequential frequency down-conversion mechanism, to significantly reduce the power consumption required for MIPI transmission. Since the AP may transmit display data with an extremely low frame rate such as 1 Hz, the blank interval may reach the length of 119 or 59 frame periods. In order to further enhance the power saving effect, the AP may stop sending the horizontal synchronization signal HS, e.g., by turning off the transmission interface of MIPI, in the blank interval; instead, the AP may use a GPO interface to send the horizontal synchronization signal HS. Alternatively, the AP may stop sending the horizontal synchronization signal HS in the blank interval; instead, the DDIC may generate the horizontal synchronization signal HS internally to use the internal horizontal synchronization signal HS to perform necessary display timing control.

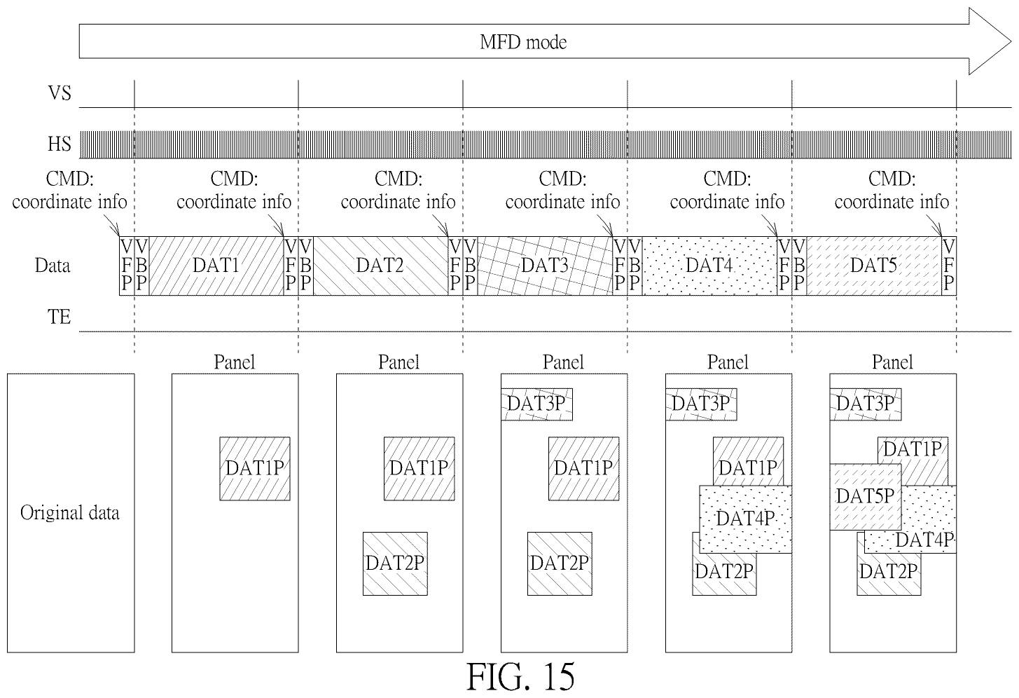

In the MFD mode, in addition to the more common frame rate allocation in the vertical direction, the new generation MFD scheme may combine the frame rate allocation in the vertical direction and the horizontal direction. For example, as shown in FIG. 15, the display system supports vertical and horizontal MFD control, and the AP may transmit the display data (e.g., DAT1-DAT5) and also send the information of partial refresh positions in the corresponding commands. This position information may include the coordinate information in both X-direction and Y-direction, so that the DDIC may refresh the pixels in specific areas of the display panel indicated by the coordinate information. With the combination of frame rate allocation in the vertical direction and the horizontal direction, the areas that need to be refreshed with partial display data DAT1P-DAT5P in an image frame may include partial lines of pixels, thereby achieving more flexible MFD control and optimizing the power saving effects achieved by the MED operations.

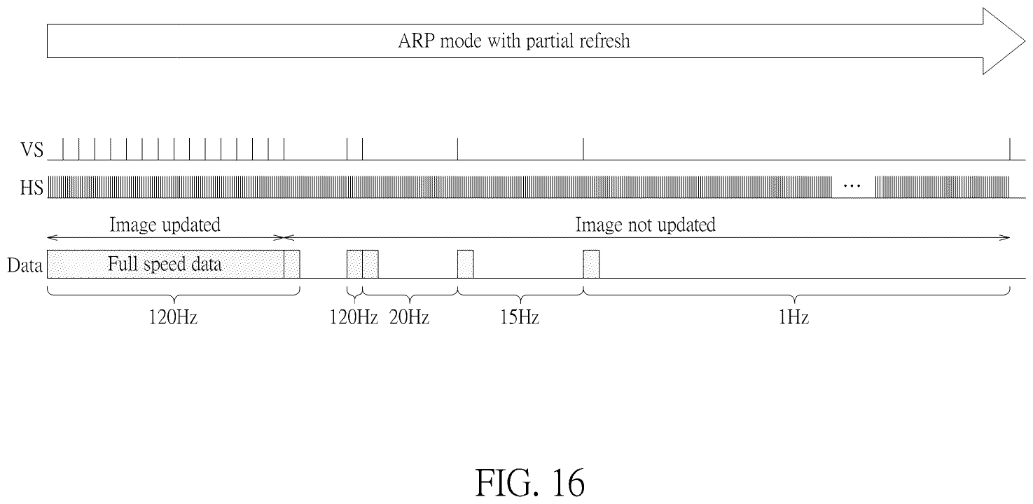

In another embodiment, the MED operation may be integrated with the ARP mode. For example, as shown in FIG. 16, the DDIC may be configured to remain in the ARP mode and also support the MED functions. In detail, the DDIC in the ARP mode may directly perform partial refresh based on the information of the positions or display lines to be refreshed provided by the AP, and the image sending frequency may be completely controlled by the AP. In this embodiment, the DDIC may perform panel refresh entirely based on the vertical synchronization signal VS and the information of the positions or display lines to be refreshed provided by the AP. More specifically, during the time periods where dynamic images are displayed, the AP may continuously transmit updated display data to the DDIC at a full speed; during the time periods where still images are displayed (where the images are not updated), the AP may automatically trigger the sequential frequency down-conversion to save power. No additional timing control mechanism of the DDIC is incorporated, and the operation mode may not be switched.

In this embodiment, since the panel refresh is solely based on the display data provided by the AP, when the display data received by the DDIC is accompanied by the corresponding information of the areas to be refreshed, the DDIC may refresh the corresponding pixels based on this information. If a frame of images needs to perform full refresh, the AP may send the information about the areas to be refreshed covering the entire panel to the DDIC, or alternatively send no information of partial refresh; hence, the DDIC may know that the display panel needs to be fully refreshed and thereby perform the full refresh operation.

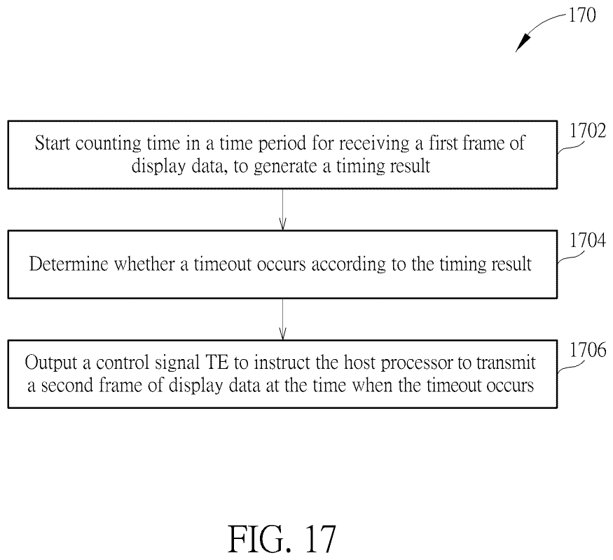

The abovementioned operations of data transmission and panel refresh may be summarized into a control process 170, as shown in FIG. 17. The control process 170 may be implemented in a display driver circuit, such as the DDIC in any of the above embodiments. As shown in FIG. 17, the control process 170 includes the following steps:

Step 1702: Start counting time in a time period for receiving a first frame of display data, to generate a timing result.

Step 1704: Determine whether a timeout occurs according to the timing result.

Step 1706: Output a control signal TE to instruct the host processor to transmit a second frame of display data at the time when the timeout occurs.

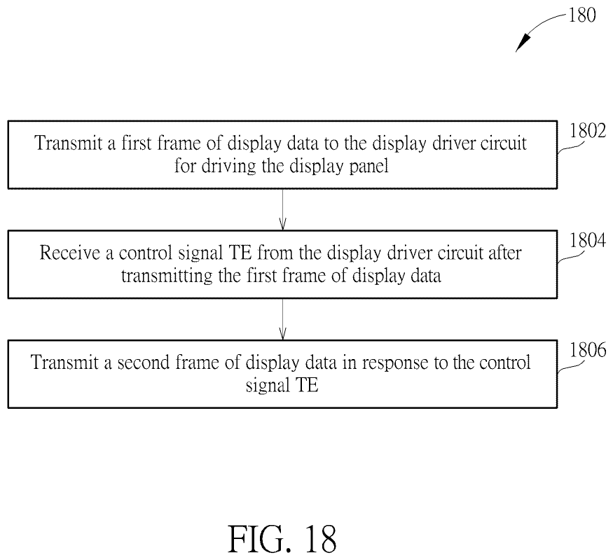

Note that the abovementioned operations of data transmission and panel refresh may also be summarized into another control process 180, as shown in FIG. 18. The control process 180 may be implemented in a host processor, such as the AP in any of the above embodiments. As shown in FIG. 18, the control process 180 includes the following steps:

Step 1802: Transmit a first frame of display data to the display driver circuit for driving the display panel.

Step 1804: Receive a control signal TE from the display driver circuit after transmitting the first frame of display data.

Step 1806: Transmit a second frame of display data in response to the control signal TE.

The detailed operations and alterations of the control processes 170 and 180 are illustrated in the above descriptions, and will not be narrated herein.

To sum up, the present invention may integrate the applications of MFD and ARP in the MIPI video mode. In addition to keeping the cost advantage of RAM-less in the video mode, the partial refresh mechanism may also be used to reduce the panel refresh area to save power consumption. The sequential frequency down-conversion mechanism of the ARP is also utilized to achieve an extremely low refresh rate, to achieve the purpose of power saving without affecting visual effects. In addition to the decrease in the refresh rate of the display panel, the data quantities sent through MIPI may also be reduced significantly, so as to further enhance power saving effects. In addition, in the present invention, the DDIC may be switched between the MED mode and the ARP mode by itself without being indicated by any commands or notifications sent by the AP, which may further improve the efficiency of display operations. In detail, the DDIC in the MFD mode may count time to determine that the AP does not update images when a timeout occurs (which means that the transmission of display data is lower than a certain frequency), and enter the ARP mode to perform sequential frequency down-conversion to save power of the MIPI. The DDIC in the ARP mode may automatically enter the MED mode when receiving the images actively sent by the AP, and start to perform the partial refresh display in the MED mode.

In an embodiment, in order to ensure the display quality, the DDIC may forcibly perform full refresh in the first N frame periods after entering the MFD mode, and send the control signals TE in the corresponding time points to instruct the AP to send images. In an embodiment, the DDIC use may the sequential frequency down-conversion control in the MFD mode to ensure the visual effects in low frame rate areas (i.e., the still image areas). In an embodiment, the AP is allowed to transmit only the display data to be refreshed to the DDIC, so that the DDIC performs partial refresh according to the received display data, and/or along with the indication of the areas to be refreshed. In an embodiment, the AP may stop sending the horizontal synchronization signal after completely sending the images, and the DDIC changes to use the internal horizontal synchronization signal to perform timing control of the display panel. In an embodiment, the information of the areas to be refreshed sent by the AP includes the coordinate information of pixels in the horizontal and vertical directions, so that the DDIC may perform partial refresh display in the horizontal and vertical directions accordingly. In an embodiment, the DDIC may perform partial refresh based on the display lines to be refreshed provided by the AP in the ARP mode, and the panel refresh is directly controlled by the AP. Except for contradictory or non-implementable situations, the above embodiments may be combined with each other to further enhance the power saving effect and improve the display quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a display panel for a display driver circuit, comprising:
starting counting time in a time period for receiving a first frame of display data, to generate a timing result;
determining whether a timeout occurs according to the timing result; and
outputting a control signal to instruct a host processor to transmit a second frame of display data at a time when the timeout occurs.

2. The method of claim 1, wherein the display driver circuit is operated in a first operation mode, and the method further comprises:
leaving the first operation mode to enter a second operation mode when the timeout occurs.

3. The method of claim 2, wherein the first operation mode comprises a multi-frequency display (MFD) operation, and the second operation mode does not comprise the MED operation.

4. The method of claim 3, wherein in the MFD operation, the display driver circuit performs partial refresh with the first frame of display data.

5. The method of claim 2, further comprising:
starting to receive a plurality of display data with sequentially down-converted frequencies in the second operation mode.

6. The method of claim 5, wherein the plurality of display data with the sequentially down-converted frequencies are triggered by outputting a plurality of control signals to the host processor.

7. The method of claim 5, wherein the plurality of display data keep unchanged when the display driver circuit is in the second operation mode.

8. The method of claim 5, wherein the plurality of display data are transmitted with a start frequency, which is determined according to a timeout length.

9. The method of claim 2, further comprising:
performing full refresh with a plurality of display data of a predetermined number of frames after entering the first operation mode from the second operation mode.

10. The method of claim 2, wherein the display driver circuit is in the second operation mode, and the method further comprises:
receiving a third frame of display data which is not in response to the control signal; and
leaving the second operation mode to enter the first operation mode when receiving the third frame of display data.

11. The method of claim 2, wherein the display driver circuit is in the first operation mode, and the method further comprises:
outputting a plurality of control signals to instruct the host processor to transmit a plurality of entire frames of display data with sequentially down-converted frequencies;
receiving the plurality of entire frames of display data; and
refreshing the display panel with the plurality of entire frames of display data using the sequentially down-converted frequencies.

12. The method of claim 1, wherein the step of starting counting time in the time period for receiving the first frame of display data comprises:
starting counting time when receiving a synchronization signal for the first frame of display data.

13. The method of claim 1, wherein the step of starting counting time in the time period for receiving the first frame of display data comprises:
starting counting time when the time period for receiving the first frame of display data starts.

14. The method of claim 1, wherein the step of determining whether the timeout occurs according to the timing result comprises:
determining that the timeout occurs when the timing result indicates that no vertical synchronization signal is received for a predetermined period of time.

15. The method of claim 1, further comprising:
performing full refresh with the second frame of display data.

16. The method of claim 1, wherein the display driver circuit is operated in a first operation mode, and the method further comprises:
leaving the first operation mode to enter a second operation mode without being instructed by a command received from the host processor.

17. The method of claim 1, wherein the display driver circuit comprises a timeout counter used for determining whether the timeout occurs.

18. A display driver circuit for controlling a display panel, to:
start counting time in a time period for receiving a first frame of display data, to generate a timing result;
determine whether a timeout occurs according to the timing result; and
output a control signal to instruct a host processor to transmit a second frame of display data at a time when the timeout occurs.

19. A method of controlling a display panel for a host processor, comprising:
transmitting a first frame of display data to a display driver circuit for driving the display panel;
receiving a control signal from the display driver circuit after transmitting the first frame of display data; and
transmitting a second frame of display data in response to the control signal.

20. The method of claim 19, wherein the control signal is generated according to a timing result of the display driver circuit.

21. The method of claim 20, wherein the display driver circuit is operated in a first operation mode, and leaves the first operation mode to enter a second operation mode according to the timing result.

22. The method of claim 21, wherein the first operation mode comprises a multi-frequency display (MFD) operation, and the second operation mode does not comprise the MFD operation.

23. The method of claim 22, wherein in the MED operation, the display driver circuit performs partial refresh with the first frame of display data.

24. The method of claim 21, further comprising:
starting to transmit a plurality of display data with sequentially down-converted frequencies after receiving the control signal.

25. The method of claim 24, wherein the plurality of display data with the sequentially down-converted frequencies are triggered by receiving a plurality of control signals from the display driver circuit.

26. The method of claim 24, wherein the plurality of display data keep unchanged when the display driver circuit is in the second operation mode.

27. The method of claim 24, further comprising:
transmitting the plurality of display data with a start frequency, which is determined according to a timeout length of the display driver circuit.

28. The method of claim 21, wherein the display driver circuit is in the second operation mode, and the method further comprises:
transmitting a third frame of display data which is not in response to the control signal to the display driver circuit;
wherein the display driver circuit leaves the second operation mode to enter the first operation mode when receiving the third frame of display data.

29. The method of claim 19, further comprising:
transmitting a plurality of entire frames of display data in response to a plurality of control signals received from the display driver circuit;
wherein the plurality of entire frames of display data are used to refresh the display panel with sequentially down-converted frequencies.

30. The method of claim 21, wherein the host processor does not send a command to the display driver circuit to instruct the display driver circuit to leave the first operation mode to enter the second operation mode.

31. A host processor for controlling a display panel, to:
transmit a first frame of display data to a display driver circuit for driving the display panel;
receive a control signal from the display driver circuit after transmitting the first frame of display data; and
transmit a second frame of display data in response to the control signal.
